(19) United States
(12) Patent Application Publication
(10) Pub. No.: US 2004/0123695 A1
(43) Pub. Date: Jul. 1, 2004

(54) Steering wheel tilt mechanism

(76) Inventors: Jeffrey A. Knott, Eastpointe, MI (US); Clifford S. Dirksen, Grosse Pointe Farms, MI (US)

Correspondence Address: HARNESS, DICKEY & PIERCE, P.L.C., P.O. BOX 828, BLOOMFIELD HILLS, MI, 48303, US

(21) Appl. No.: 10/684,607

(22) Filed: Oct. 14, 2003

Related U.S. Application Data
(60) Provisional application No. 60/418,598, filed on Oct. 15, 2002.

(51) Int. Cl. B62D 1/18

(52) U.S. Cl. 74/493

(57) ABSTRACT

A steering wheel tilt mechanism includes a first steering column section and a second steering column section pivotally coupled to one another. A lock assembly selectively restricts pivotal movement of the first steering column section relative to the second steering column section. The lock assembly includes a shaft and a cam roller selectively engagable with the shaft. When the cam roller is disengaged, the shaft is free to translate thereby allowing pivotal movement of the first steering column section relative to the second steering column section.

### CROSS-REFERENCE TO RELATED APPLICATIONS

This application claims the benefit of U.S. Provisional Application No. 60/418,598 filed on Oct. 15, 2002. The disclosure of the above application is incorporated herein by reference.

### FIELD OF THE INVENTION

The present invention generally relates to tilt steering wheels for vehicles and, more particularly, to a simplified locking mechanism for selectively fixing the angular position of the steering wheel.

### BACKGROUND OF THE INVENTION

Steering columns equipped with a pivotable tilt wheel have been constructed for a number of years. One example of a known steering column incorporates a housing having a “double-D” bore with grooves formed on the arcuate portions of the bore. A double-D shaped shaft having threads on the arcuate portions is positioned within the housing bore. Depending on the rotational orientation of the shaft, the threads of the two parts are either engaged or disengaged. When the threads are disengaged, the shaft may slide within the housing to allow the steering wheel to tilt. The shaft is no longer free to slide when the threads are engaged. The double-D design requires additional sleeves and coupling components to properly function. In addition, special component processing is required to form the D-shaped bore and shaft. As such, this steering column is relatively expensive to produce and maintain.

Another known steering column utilizes a shaft having a series of teeth formed on a flat portion of the shaft. A pawl having a series of teeth located on one end is pivotally mounted to the steering column such that the pawl teeth may be selectively engaged and disengaged with the teeth on the shaft. Unfortunately, some steering columns incorporating the pivoting pawl design are unable to withstand high loads as required by certain vehicle manufacturers.

The tilt wheel of the present invention includes a first steering column section and a second steering column section pivotally coupled to the first steering column section. A lock assembly selectively restricts pivotal movement of the first steering column section relative to the second steering column section. The lock assembly includes a housing, a shaft and a cam roller. The shaft has one end coupled to the first steering column section and a second end slidingly positioned within the housing. The shaft includes a portion having external thread. The cam roller is pivotally coupled to the housing and has a pivot axis substantially parallel to a longitudinal axis of the shaft that is offset from a longitudinal centerline of the cam roller. The cam roller includes an external thread selectively engageable with the external thread of the shaft thereby selectively restricting pivotal movement of said first steering column section relative to said second steering column section.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The foregoing and other features of the present invention will become apparent to one skilled in the art upon consideration of the following description of the invention and the accompanying drawings in which:

FIG. 1 is a perspective view of a steering wheel tilt mechanism constructed in accordance with the teachings of the present invention;

FIG. 2 is an enlarged partial perspective view of the steering wheel tilt mechanism of the present invention;

FIG. 3 is an exploded perspective view of a locking mechanism of the present invention;

FIG. 4 is a partial cross-sectional end view of the steering wheel tilt mechanism of the present invention depicting a cam roller in an engaged position;

FIG. 5 is a partial cross-sectional end view of the steering wheel tilt mechanism of the present invention depicting a cam roller in a disengaged position;

FIG. 6 is a partial cross-sectional side view of the steering wheel tilt mechanism of the present invention depicting the shaft at one extreme articulated position;

FIG. 7 is a partial cross-sectional side view of the steering wheel tilt mechanism of the present invention depicting the shaft at an opposite extreme position to that shown in FIG. 6;

FIG. 8 is a partial cross-sectional side view of the steering wheel tilt mechanism of the present invention depicting the shaft at an intermediate position;

FIG. 9 is a partial perspective view depicting a release mechanism of the present invention;

FIG. 10 is a partial perspective view depicting an alternate release mechanism of the present invention;

FIG. 11 is a perspective view of an alternate embodiment locking mechanism of the present invention;

FIG. 12 is an exploded perspective view of the locking mechanism of FIG. 11;

FIG. 13 is a partial cross-sectional side view of the locking mechanism depicted in FIG. 12;

FIG. 14 is a partial cross-sectional end view of the locking mechanism depicted in FIG. 12; and

FIG. 15 is a perspective view of an alternate embodiment steering wheel tilt mechanism including the alternate embodiment locking mechanism of FIG. 11.

### DETAILED DESCRIPTION OF THE PREFERRED EMBODIMENT

The following description of the preferred embodiment is merely exemplary in nature and is in no way intended to limit the invention, its application, or uses.

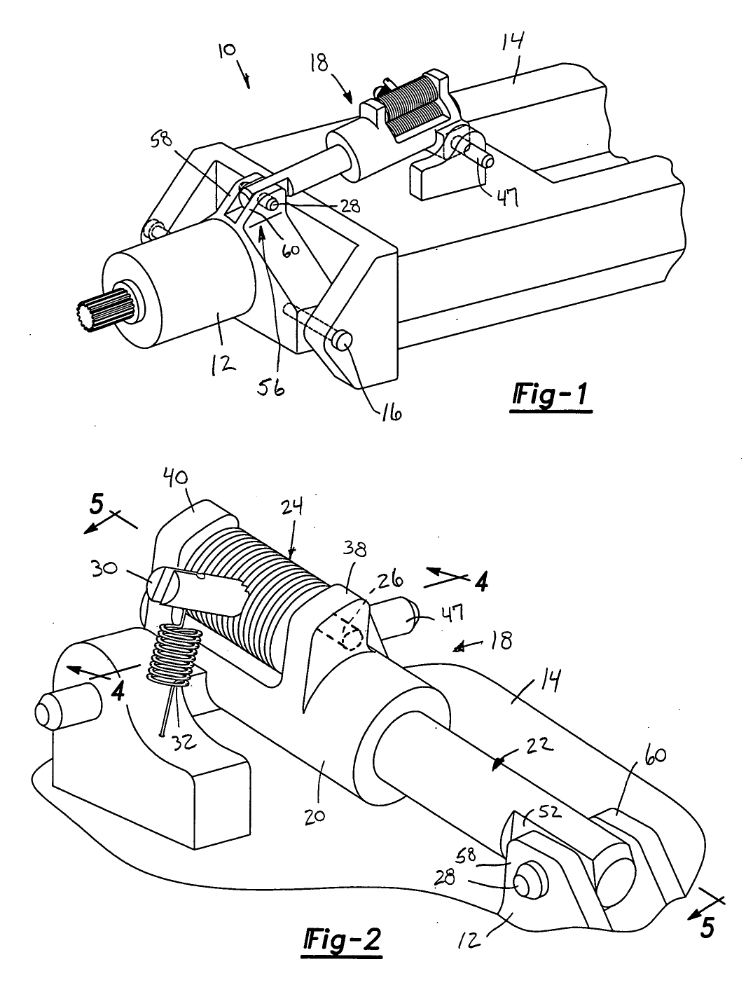

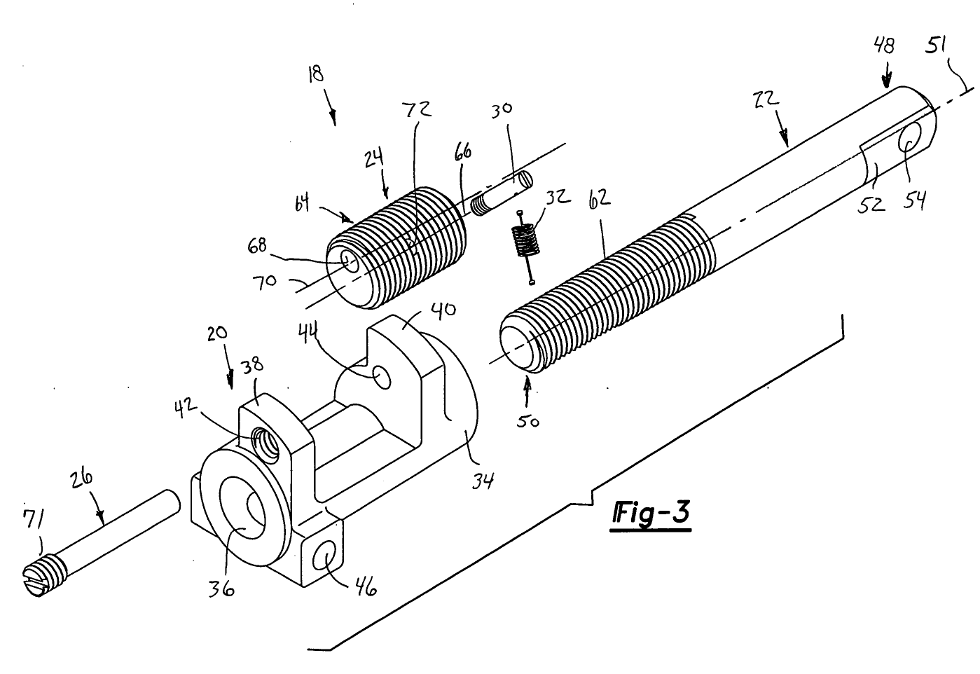

With reference to FIGS. 1-3, a steering wheel tilt mechanism constructed in accordance with the teachings of the present invention is depicted at reference numeral 10. Steering wheel tilt mechanism 10 includes a first steering column section 12 and a second steering column section 14 pivotally coupled to one another via pins 16. A lock assembly 18 also interconnects first steering column section 12 and second steering column section 14. Lock assembly 18 functions to selectively fix the angular or tilt position of a steering wheel (not shown) coupled to first steering column section 12. Lock assembly 18 may be operated in a locked position and an unlocked position. In the locked position, the position of first steering column section 12 is fixed relative to second steering column section 14. In the unlocked position, first steering column section 12 may be rotated about the centerline of pins 16 to tilt the steering wheel.

Lock assembly 18 includes a housing 20, a shaft 22, a cam roller 24, a cam pin 26, a shaft pin 28, a torque arm 30 and a spring 32. Housing 20 includes a generally cylindrical body 34 having a bore 36 extending longitudinally therethrough. Housing 20 also includes a first stanchion 38 and a second stanchion 40 protruding radially outwardly from body 34. A threaded aperture 42 extends through first stanchion 38. A smooth bore aperture 44 is located in second stanchion 40. Apertures 42 and 44 are axially aligned with one another substantially parallel to bore 36. Housing 20 also includes a bore 46 transversely extending through body 34. Bore 46 partially intersects bore 36.

A housing pivot pin 47 rotatably couples housing 20 and second steering column section 14. Based on the location of bore 46, housing pivot pin 47 partially protrudes into bore 36. As described in greater detail hereinafter, housing pivot pin 47 functions as a stop to limit the travel of shaft 22 and the range of tilt angle available to the user.

Shaft 22 is a generally cylindrical member having a first end 48, a second end 50, and a longitudinal axis 51. First end 48 has a pair of flats 52 formed along a portion of the shaft. A pin aperture 54 extends transversely through the shaft and is sized for receipt of shaft pin 28. Shaft 22 is positioned within bore 36 of housing 20. First end 48 of shaft 22 is pivotally coupled to first steering column section 12.

First steering column section 12 includes a bifurcated portion 56 having a first leg 58 and a second leg 60. Each of first and second legs 58 and 60 include apertures sized for receipt of shaft pin 28. First leg 58 and second leg 60 are spaced apart a distance corresponding to the distance across flats 52 of first end 48. Accordingly, shaft 22 is restrained from rotation about longitudinal axis 51 by shaft pin 28, flats 52 and first and second legs 58 and 60. Second end 50 of shaft 22 includes an external thread 62 extending along a portion of shaft 22. Second end 50 is free to axially translate within bore 36.

Cam roller 24 includes an external thread 64 selectively engageable with external thread 62 to fix the axial location of shaft 22. Cam roller 24 is a generally cylindrical member having a longitudinal axis 66. A pivot bore 68 extends through cam roller 24 along a pivot axis 70. Pivot axis 70 extends substantially parallel to longitudinal axis 66 and offset therefrom thereby forming an eccentrically pivotable cam. Cam pin 26 is positioned within pivot bore 68 to provide an offset center for rotation. An end 71 of cam pin 26 is threaded for engagement with threaded aperture 42 of housing 20.

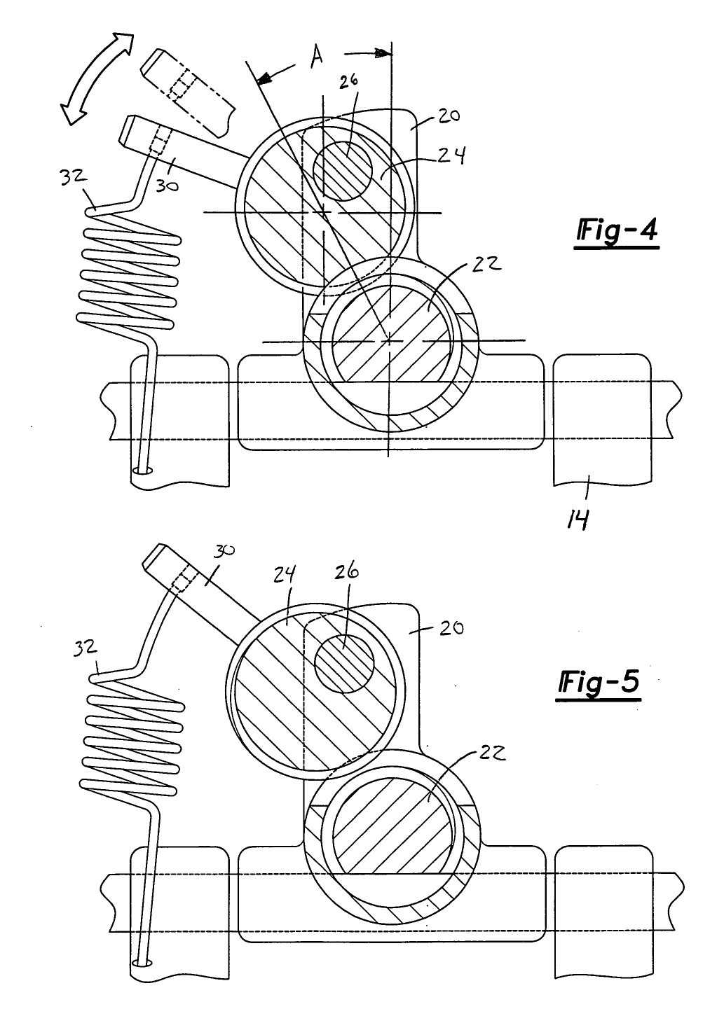

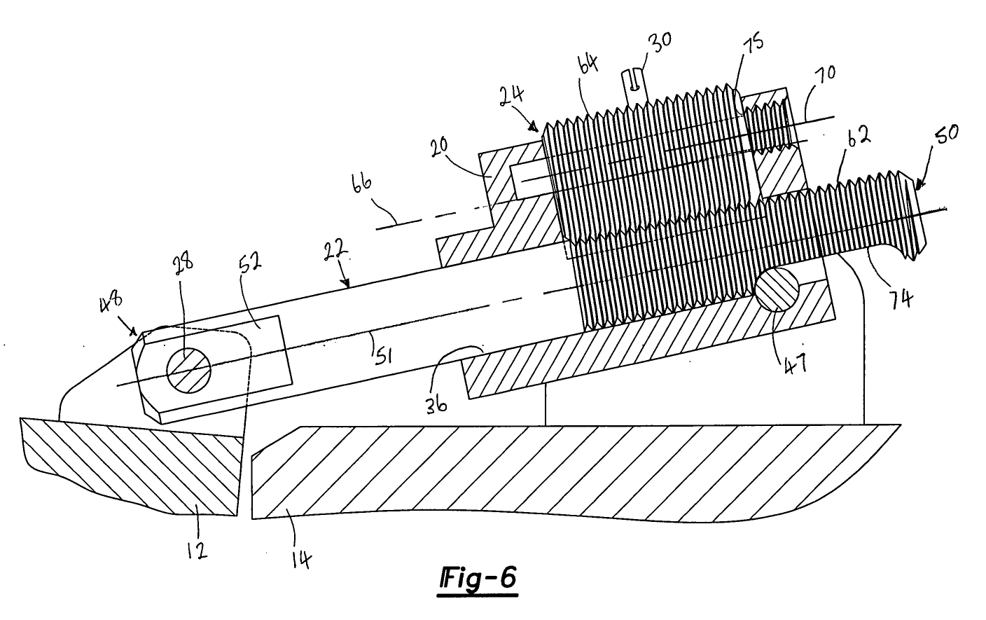

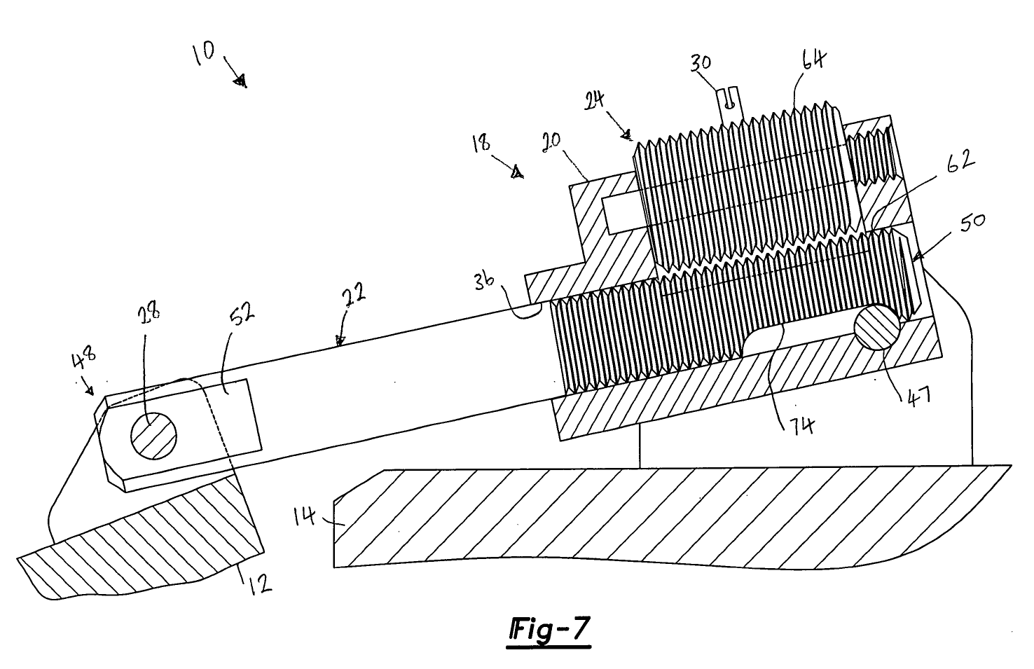

Cam roller 24 includes a threaded recess 72 transversely extending into the cam roller. Torque arm 30 is threadingly engaged within recess 72 to assist the user in positioning cam roller 24. Spring 32 interconnects torque arm 30 and second steering column section 14 to biasedly load cam roller 24 to an engaged position depicted in FIGS. 4 and 6. The phantom line representation of torque arm 30 corresponds to a disengaged cam roller fully depicted in FIGS. 5 and 7. In the engaged position (FIGS. 4 and 6), external thread 64 of cam roller 24 mates with external thread 62 of shaft 22. To provide a load bearing interconnection, cam roller 24 has the same hand thread of the same pitch as compared to the thread on shaft 22. It should be appreciated that cam roller 24 and shaft 22 may include engageable or interlocking geometrical shapes such as square teeth or ridges without departing from the scope of the present invention.

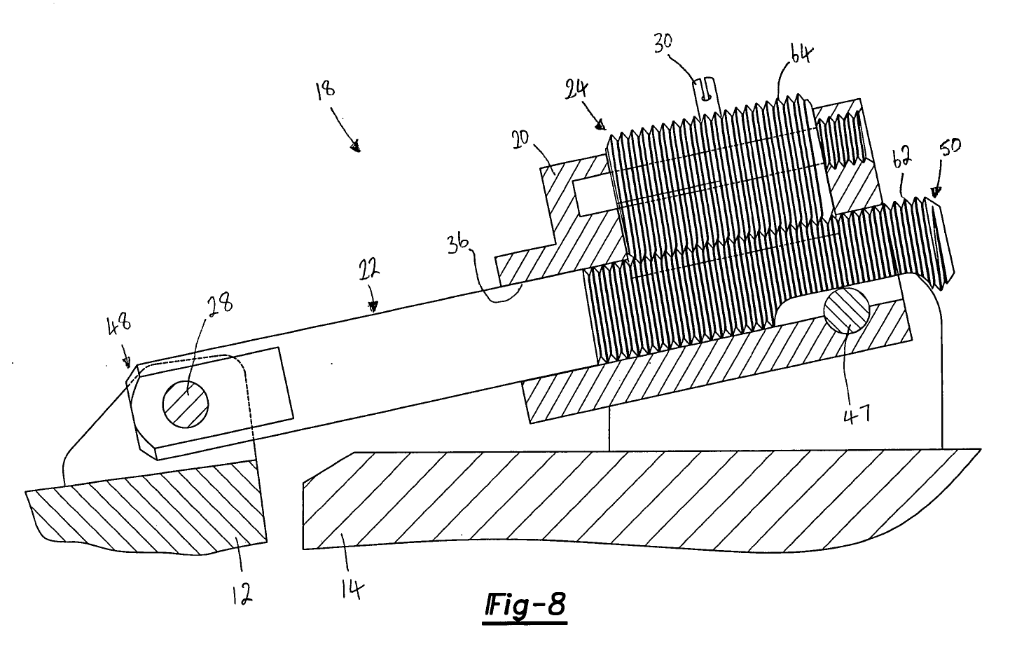

With reference to FIGS. 5 and 7, cam roller 24 is shown in the disengaged position. Cam roller 24 may be rotated about pivot axis 70 by applying a force to overcome the tension within spring 32 and the frictional forces associated with the engagement of the external threads. Once cam roller 24 is located in the disengaged position, shaft 22 is free to translate within bore 36. Translation of shaft 22 corresponds to pivotal movement of first steering column section 12 relative to second steering column section 14. The range of tilt available to a vehicle operator is defined by the length of a slot 74 transversely extending along shaft 22. Housing pivot pin 47 functions to limit the translation of shaft 22 and correspondingly the tilt angle of the steering wheel. FIGS. 6 and 7 depict the full range of shaft translation. An exemplary intermediate position is shown in FIG. 8.

As mentioned earlier, it is desirable to selectively and securely fix the position of first steering column section 12 relative to second steering column section 14 after the desired steering wheel angle has been set. Any chucking or up-and-down movement of the steering wheel after cam roller 24 has been moved to the engaged position is undesirable. To assure shaft 22 remains stationary relative to housing 20, cam roller 24 is nested between first stanchion 38 and second stanchion 40 with very little clearance between the stanchions and the cam roller. Cam pin 26 may be used to provide an alternate method of limiting the axial movement of cam roller 24 along pivot axis 70. As shown in FIG. 6, cam pin 26 includes a shoulder 75 which may be driven against an end of cam roller 24 to effectively reduce or eliminate the clearance between the stanchions and cam roller 24. Cam pin 26 may be fixed relative to housing 20 via a mechanical crimping process or thread adhesive.

Steering wheel chuck is further eliminated by assuring that shaft 22 is only free to translate within bore 36 and not rotate about axis 51. As mentioned earlier, first end 48 of shaft 22 is pinned and restrained against rotation by first steering column section 12. Finally, the pitch angle of threads 62 and 64 serve to load cam roller 24 against one of first stanchion 38 or second stanchion 40 depending on the orientation of the thread forms. The combination of the aforementioned features provides a tilt wheel steering mechanism operable to allow adjustment of the tilt angle of the steering wheel and rigid fixation once the desired tilt angle has been set.

Furthermore, it should be appreciated that cam roller 24 is positioned relative to shaft 22 to provide an optimized engagement between thread 62 and thread 64. With specific reference to FIG. 4, an angle A is defined by the angle between vertical and a line interconnecting the centers of shaft 22 and cam roller 24 when cam roller 24 is in the engaged position. Preferably angle A ranges from approximately 10 to 30 degrees to assure that cam roller 24 may not roll past shaft 22 and become disengaged with the shaft. Also, angle A is sized to minimize the force required from spring 32 to engage the threads of cam roller 24 with the threads of shaft 22. However, one skilled in the art will appreciate that any number of cam roller sizes and relative positions may be utilized without departing from the scope of the present invention.

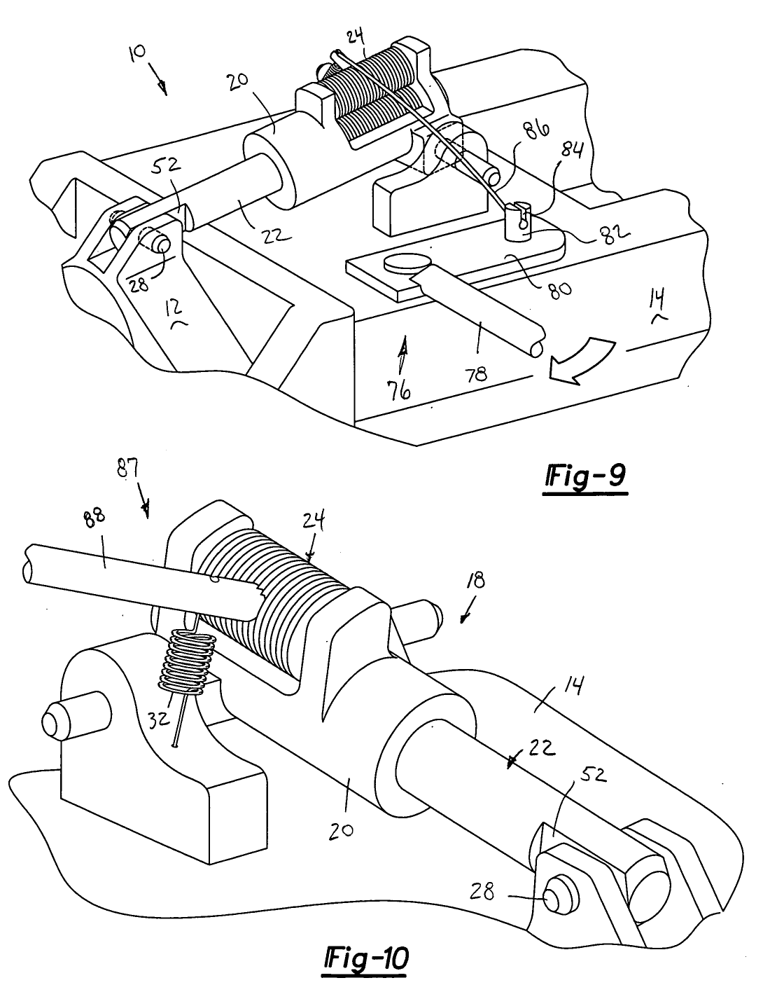

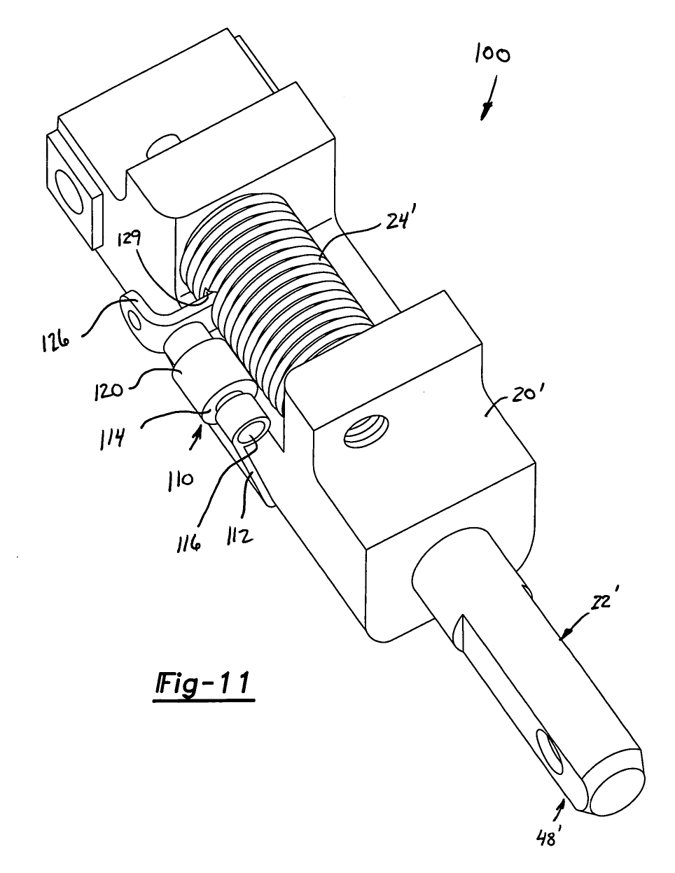

FIG. 9 depicts a release mechanism 76 operably coupled to lock assembly 18. Release mechanism 76 includes a lever 78 fixed to a plate 80. Plate 80 is pivotally mounted on second steering column section 14 via a pin 82. Pin 82 includes a slot 84 for receipt of one end of a cable 86. The opposite end of cable 86 is coupled to torque arm 30. As such, rotation of lever 78 by the vehicle operator causes cam roller 24 to pivot about pivot axis 70 toward the disengaged position. Once cam roller 24 is in the disengaged position, the operator may move the steering wheel to the desired tilt location. To maintain the present steering wheel tilt location, the operator simply releases lever 78. Spring 32 rotates cam roller 24 about pivot axis 70 to engage external thread 64 with thread 62 of shaft 22 as previously described.

FIG. 10 depicts an alternate release mechanism 87. Release mechanism 87 includes a lever 88 directly coupled to cam roller 24. It should be appreciated that a variety of release mechanisms may be utilized in conjunction with the present invention to accommodate specific vehicle configuration and mounting conditions. Furthermore, spring 32 and torque arm 30 are merely exemplary components used to impart a torque upon cam roller 24 toward the engaged position. A variety of biasing members such as torsion springs and belleville washers are contemplated as being within the scope of the present invention.

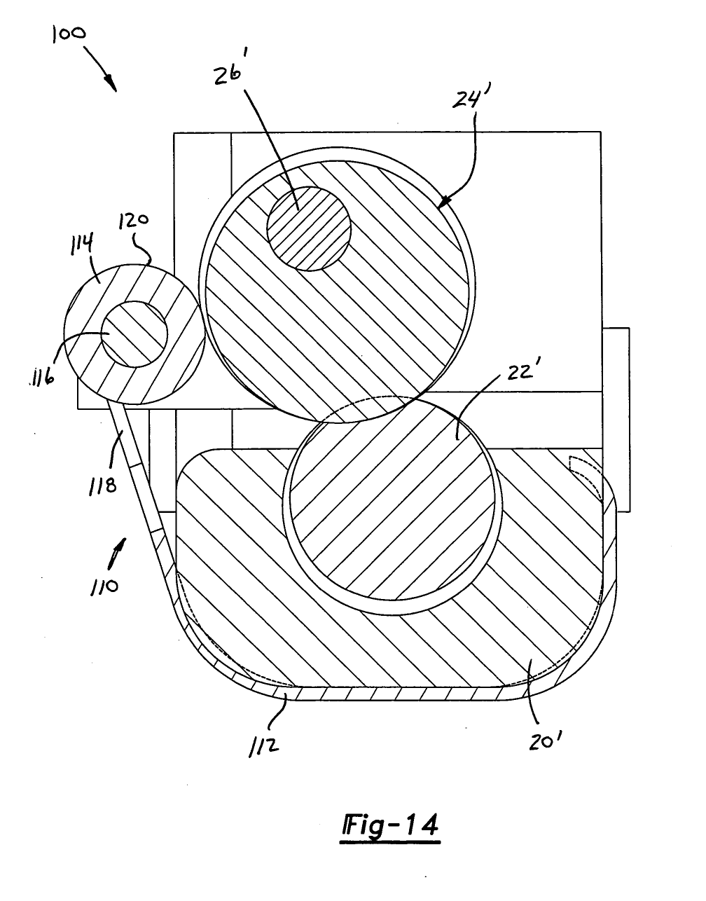

Specifically, another alternate embodiment lock assembly 100 is depicted in FIGS. 11-14. One skilled in the art will appreciate that lock assembly 100 is substantially similar to lock assembly 18. As such, similar components will be identified with like numerals with the addition of a prime suffix.

Lock assembly 100 functions substantially similarly to lock assembly 18. However, shaft 22′ need not be machined to include a transverse slot for limiting its axial travel. Housing 20′ includes a counterbore 102 having a first portion 104 of a greater diameter than a second portion 106. Portion 106 is sized to allow first end 48′ of shaft 22′ to extend therethrough. Second end 50′ of shaft 22′ is sized to axially translate within portion 104 of bore 102 but is restricted from entering portion 106. A stop 108 is coupled to housing 20′ and at least partially intrudes within portion 104 of counterbore 102. Stop 108 is depicted as a cylindrical pin pressed into housing 20′. However, it should be appreciated that any number of members having varying shapes could be inserted within portion 104 to limit the axial travel of shaft 22′.

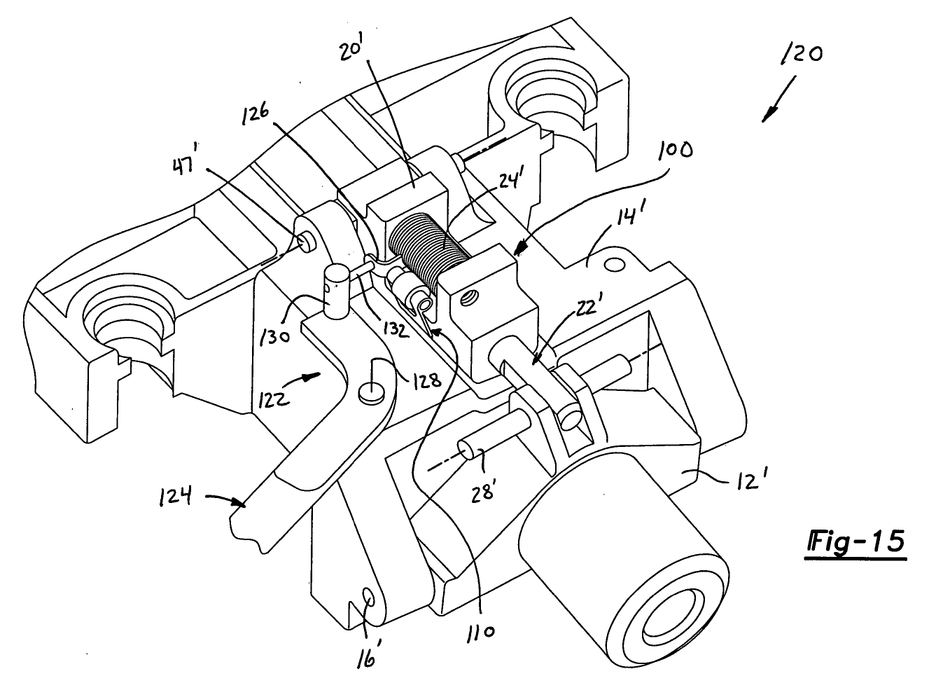

A clip assembly 110 biasedly urges cam roller 24′ into engagement with shaft 22′. Clip assembly 110 includes a retainer 112, a roller 114 and a pin 116. Pin 116 rotatably interconnects roller 114 and retainer 112. Retainer 112 is sized and shaped to envelop at least a portion of housing 20′. Retainer 112 is preferably constructed from a resilient material such as a spring steel and biasedly engages housing 20′ to couple clip assembly 110 to housing 20′. Retainer 112 includes a pair of bifurcated legs 118 spaced apart from one another. Roller 114 is positioned between legs 118. As best shown in FIG. 14, an outer surface 120 of roller 114 biasedly engages cam roller 24′. Legs 118 are positioned to ensure that cam roller 24′ is urged toward shaft 22‘throughout the cam roller’s range of articulation.

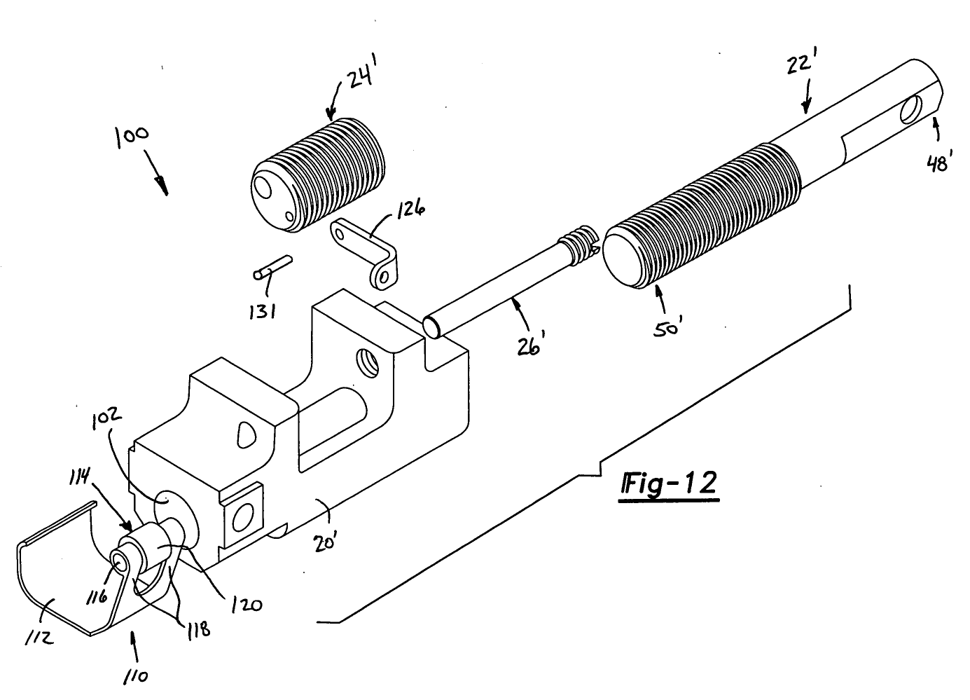

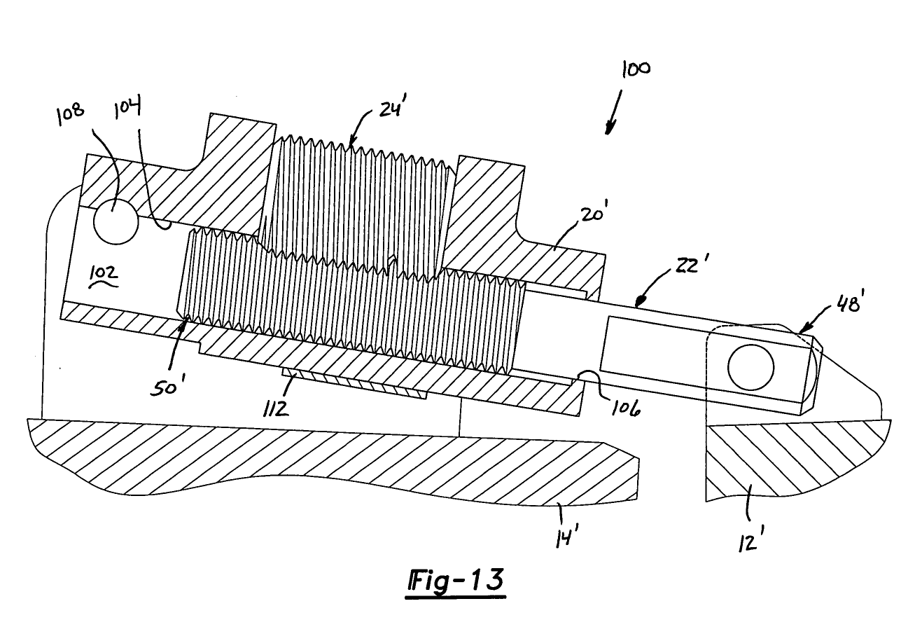

An alternate embodiment steering wheel tilt mechanism 120 is depicted in FIG. 15. Steering wheel tilt mechanism 120 includes a release mechanism 122 having a lever 124 and an arm 126. A pin 128 pivotally couples lever 124 to second steering column section 14′. Arm 126 is positioned within a slot 129 and coupled to cam roller 24′ with a fastener 131 as shown in FIGS. 11 and 12. Lever 124 includes an upstanding post 130. A connector pin 132 couples arm 126 and post 130. During adjustment of the tilt angle of first steering column section 12′ to second steering column section 14′, an operator simply rotates lever 124 to cause cam roller 24′ to move to a position disengaged from shaft 22′. As discussed earlier, once the outer form of roller 24′ is disengaged from the outer form of shaft 22′, first steering column section 12′ may be rotated about pin 16′. After the desired steering wheel tilt position is reached, the operator releases lever 124. Clip assembly 110 functions to return cam roller 24′ to a position engaged with shaft 22′.

The foregoing discussion discloses and describes merely exemplary embodiments of the present invention. One skilled in the art will readily recognize from such discussion, and from the accompanying drawings and claims, that various changes, modifications and variations may be made therein without department from the spirit and scope of the invention as defined in the following claims.

What is claimed is:

1. A steering wheel tilt mechanism comprising:
a first steering column section;
a second steering column section pivotally coupled to the first steering column section;
a lock assembly selectively restricting pivotal movement of the first steering column section relative to the second steering column section, wherein the lock assembly includes:
a housing;
a shaft having a longitudinal axis, one end coupled to the first steering column section and a second end slidingly positioned within the housing, wherein the shaft includes a portion having external form;
a substantially cylindrical cam roller pivotally coupled to the housing, the cam roller having a pivot axis substantially parallel to the longitudinal axis of the shaft and offset from a longitudinal centerline of the cam roller, wherein the cam roller includes an external form selectively engageable with the external form of the shaft to selectively restrict pivotal movement of the first steering column section relative to the second steering column section.

2. The steering wheel tilt mechanism of claim 1 wherein the external form of the cam roller is biasedly engaged with the external form of the shaft.

3. The steering wheel tilt mechanism of claim 2 further including a spring clip coupled to the housing, the spring clip including a portion biasing the cam roller into engagement with the shaft.

4. The steering wheel tilt mechanism of claim 1 wherein the shaft includes a slot having a predetermined width and the tilt mechanism further includes a stop fixed to the housing and positioned within the slot, a clearance between the slot and the stop defining a maximum amount of travel available to the shaft.

5. The steering wheel tilt mechanism of claim 1 wherein the housing includes a stepped bore to limit the travel of the shaft.

6. The steering wheel tilt mechanism of claim 5 further including a stop fixed to the housing, the stop being positioned to limit the axial travel of the shaft along the longitudinal axis.

7. The steering wheel tilt mechanism of claim 1 wherein the external form on the shaft is a helical thread.

8. The steering wheel tilt mechanism of claim 7 wherein the external form on the cam roller is a helical thread.

9. The steering wheel tilt mechanism of claim 8 wherein the helical threads of the shaft and the cam roller have the same pitch and hand.

10. The steering wheel tilt mechanism of claim 1 wherein a longitudinal centerline of the cam roller and the longitudinal centerline of the shaft are aligned along a plane rotated an angle ranging from ten to thirty degrees from a vertical plane extending through the shaft longitudinal centerline.

11. The steering wheel tilt mechanism of claim 10 wherein the pivot axis of the cam roller is positioned within the angle.

12. The steering wheel tilt mechanism of claim 1 wherein the cam roller is restricted from moving axially along the pivot axis.

13. The steering wheel tilt mechanism of claim 12 wherein the housing includes a pocket for limiting the axial movement of the cam roller.

14. The steering wheel tilt mechanism of claim 12 further including a pin rotatably coupling the cam roller and the housing, the pin including a shoulder selectively engageable with the cam roller to limit the axial travel of the cam roller relative to the housing.

15. A method of angularly positioning a steering wheel relative to a steering column, the steering column having a first section and a second section pivotally coupled to one another, a lock assembly having a housing, a shaft and a cam roller interconnects the first and second sections, the method comprising the steps of:
moving the cam roller to a position disengaged from the shaft;
moving the steering wheel to a desired rotational position;
rotating the first section relative to the second section;
axially sliding the shaft within the housing; and
moving the cam roller to a position engaged with the shaft to restrict axial movement of the shaft and fix the rotational position of the steering wheel.

16. The method of claim 15 further including selectively engaging an outer form of the cam roller with an outer form of the shaft to restrict axial movement of the shaft.

17. The method of claim 16 wherein the outer form of the cam roller is a helical thread.

18. The method of claim 15 further including restricting the distance the shaft is allowed to axially move when the cam roller is disengaged from the shaft.

19. The method of claim 15 further including positioning a pivot axis of the cam roller substantially parallel to a longitudinal axis of the shaft and offset from a longitudinal centerline of the cam roller.

20. The method of claim 15 further including moving a lever coupled to the cam roller to cause the cam roller to move between engaged and disengaged positions with the shaft.

21. The method of claim 15 further including biasing the cam roller toward the position engaged with the shaft.

22. The method of claim 15 further including limiting the axial travel of the cam roller relative to the housing.

23. The method of claim 22 further including engaging a pin with the cam roller to limit the axial travel of the cam roller relative to the housing.
